(19) United States
(12) Patent Application Publication
(10) Pub. No.: US 2024/0300254 A1
(43) Pub. Date: Sep. 12, 2024

(54) DYE SUBLIMATION PRINTING PROCESSES

(71) Applicant: Prism Inks, Inc., Sunnyvale, CA (US)

(72) Inventors: Amir A. AJANEE, Saratoga, CA (US); Graham A. DRACUP, Soquel, CA (US); Carlos J. HERNANDEZ, San Jose, CA (US); Travis T. CALHOUN, San Jose, CA (US); Omar K. AJANEE, Saratoga, CA (US)

(73) Assignee: Prism Inks, Inc., Sunnyvale, CA (US)

(21) Appl. No.: 18/594,344

(22) Filed: Mar. 4, 2024

Related U.S. Application Data
(60) Provisional application No. 63/488,585, filed on Mar. 6, 2023.

(51) Int. Cl. B41M 5/025

(52) U.S. Cl. CPC B41M 5/0256

(57) ABSTRACT

Provided are direct to film printing methods and processes for printing dye sublimation ink comprising: inkjet printing a design on a polymer coated film using dye sublimation ink; applying a polyester powder to the printed design on the polymer coated film to form a powdered printed design; melting the polyester powder; and transferring the powdered printed design from the polymer coated film to a substrate.

### CROSS-REFERENCE TO RELATED APPLICATIONS

This application claims the benefit of U.S. Provisional Application No. 63/488,585 filed Mar. 6, 2023, the entire contents of which are incorporated herein by reference.

### FIELD

This disclosure relates to printing processes, and more specifically, to direct to film transferring processes for dye sublimation inks.

### BACKGROUND

Various types of printers and printing processes currently exist for printing a design onto a substrate (e.g., textile). For example, one process includes screen printing ink onto a textile substrate and heat pressing it. A second example includes printing the ink using an inkjet printer directly to a pretreated textile substrate. A third example includes inkjetting an ink to a film and heat transferring the image to a substrate. This third example is referred to as direct to film printing.

Direct to film printing processes print an ink to a film, and then transfer the printed ink design on the film onto a substrate (e.g., textile, ceramic) to produce a printed product. Generally, direct to film printers and printing processes can be used to print a design onto a larger variety of substrate materials as compared to direct printers and direct printing processes.

### SUMMARY

Provided herein are methods and processes of printing sublimating dye inks onto various substrates using a direct to film printing process. Also provided herein are printed products prepared using the printing methods and processes described herein.

Specifically, the methods and processes described herein use a direct to film printing process that utilizes a polyester powder to transfer an inkjet printed design (using sublimating dye) onto a polymer coated film onto a substrate (e.g., natural textile, synthetic textile). The polyester powder is applied to the printed image or design, and melted by either placing the film into an oven or heat pressing it. Once the polyester powder is melted, the film is placed face down (i.e., melted powder side down) onto the substrate and pressed. This allows the printed image to transfer from the film to the substrate via the melted polyester powder.

The polyester powder used in the methods and processes described herein is used specifically because the sublimating dye pigments adequately adhere to the polyester powder when sublimating. Therefore, use of the polyester powder allows for adequate image transfer from the film to the substrate. Using the polyester powder also allows for superior dry crock and wet crock results, as well as increased color density and improved wash fastness with repeated laundering. Conversely, polymer powders that are commonly used in direct to film processes, including polyurethanes, polyacrylics, polyvinylchlorides, polyvinylacetates, polyethylene, polypropylene, polycarbonate, polystyrene, ABS, polyamides, PEEK, poly(ethylene terephthalate), poly(ether sulphone), and co/ter-polymers thereof, are not suitable for direct to film printing processes using dye sublimation ink.

In some embodiments, provided is a method for direct to film printing dye sublimation ink comprising: inkjet printing a design on a polymer coated film using dye sublimation ink; applying a polyester powder to the printed design on the polymer coated film to form a powdered printed design; melting the polyester powder; and transferring the powdered printed design from the polymer coated film to a substrate.

In some embodiments of the method, inkjet printing a design on a polymer coated film using dye sublimation ink comprises inkjet printing using an inkjet printer comprising piezo or thermal printheads.

In some embodiments of the method, melting the polyester powder comprises applying a heat source to the powdered printed design for 390-395° C. for 10-20 seconds.

In some embodiments of the method, the heat source comprises conductive heating or an infrared radiative heater.

In some embodiments of the method, transferring the powdered printed design from the polymer coated film to a substrate comprises applying a heat press to the polymer coated film comprising the powdered printed design pressed face down on the substrate.

In some embodiments of the method, the heat press is applied at 390-395° C. for 1-10 seconds.

In some embodiments of the method, after the printed design is transferred to the substrate, the polymer coated film is removed from the printed design, forming a printed substrate.

In some embodiments of the method, wherein the method comprises post pressing the printed substrate at 390-395° C. for 10-20 seconds.

In some embodiments of the method, applying a polyester powder to the printed design on the polymer coated film to form a powdered printed design comprises applying 0.03-0.05 g powder/in² ink to the printed design.

In some embodiments of the method, the substrate comprises one or more of cotton, cellulose, polyamide, polyvinylchloride, polyacrylate, or polyvinylacetate.

In some embodiments of the method, the polyester powder comprises one or more of polyethylene terephthalate, polybutylene terephthalate, polyethylene naphthalate, polytrimethylene terephthalate, polycaprolactone, polylactic acid, polyhydroxybutyrate, polyglycolide, or poly(ethylene adipate).

In some embodiments of the method, the polymer coated film is a cold peel film.

In some embodiments of the method, the polymer coated film is a hot peel film.

In some embodiments, provided is a printed product prepared from a method for direct to film printing dye sublimation ink comprising the steps of: inkjet printing a design on a polymer coated film using dye sublimation ink; applying a polyester powder to the printed design on the polymer coated film to form a powdered printed design; melting the polyester powder; and transferring the powdered printed design from the polymer coated film to a substrate to form a printed product.

In some embodiments of the printed product, inkjet printing a design on a polymer coated film using dye sublimation ink comprises inkjet printing using an inkjet printer comprising piezo or thermal printheads.

In some embodiments of the printed product, melting the polyester powder comprises applying a heat source to the powdered printed design for 390-395° C. for 10-20 seconds.

In some embodiments of the printed product, the heat source comprises conductive heating or an infrared radiative heater.

In some embodiments of the printed product, transferring the powdered printed design from the polymer coated film to a substrate comprises applying a heat press to the polymer coated film comprising the powdered printed design pressed face down on the substrate.

In some embodiments of the printed product, the heat press is applied at 390-395° C. for 1-10 seconds.

In some embodiments of the printed product, after the printed design is transferred to the substrate, the polymer coated film is removed from the printed design, forming a printed substrate.

In some embodiments of the printed product, the printed product comprises post pressing the printed substrate at 390-395° C. for 10-20 seconds.

In some embodiments of the printed product, applying a polyester powder to the printed design on the polymer coated film to form a powdered printed design comprises applying 0.03-0.05 g powder/in² ink to the printed design.

In some embodiments of the printed product, the substrate comprises one or more of cotton, cellulose, polyamide, polyvinylchloride, polyacrylate, or polyvinylacetate.

In some embodiments of the printed product, the polyester powder comprises one or more of polyethylene terephthalate, polybutylene terephthalate, polyethylene naphthalate, polytrimethylene terephthalate, polycaprolactone, polylactic acid, polyhydroxybutyrate, polyglycolide, or poly(ethylene adipate).

In some embodiments of the printed product, the polymer coated film is a cold peel film.

In some embodiments of the printed product, the polymer coated film is a hot peel film.

### BRIEF DESCRIPTION OF THE FIGURES

FIG. 1A shows a cross-sectional view of a printed image on a polymer coated film, according to some embodiments;

FIG. 1B shows a cross-sectional view of a dye sublimation ink printed image on a polymer coated film with a polyester powder applied on top of the printed image, according to some embodiments;

FIG. 1C shows a cross-sectional view of the powdered, printed image on the polymer coated film once the polyester powder has melted to form a homogenous film layer on top of the printed image, according to some embodiments;

FIG. 1D shows a cross-section view of a transferring assembly, according to some embodiments;

FIG. 1E shows a cross-sectional view of a printed substrate, according to some embodiments; and

FIG. 2 shows a method for direct to film printing using dye sublimation ink, according to some embodiments.

### DETAILED DESCRIPTION

Provided are methods of processes of direct to film printing using dye sublimation inks with a polyester powder. As explained briefly above, a polyester powder is uniquely suited for direct to film printing using dye sublimation inks, since the dye sublimation inks/pigments more adequately adhere to the polyester powder than that of other types of powders commonly used in direct to film printing methods/processes. Further, use of the polyester powder can improve dry crock and wet crock results, as well as improved color density and wash fastness with repeated laundering, particularly as compared to dye sublimation ink to 100% cotton transfer methods. These benefits are described in further detail below.

The methods and processes described herein include inkjet printing a design onto a polymer coated film using dye sublimation ink. “Dye sublimation ink” as used herein comprises dye sublimation pigments that are dispersed and stabilized in by polymer dispersants. A polyester powder is applied to the printed design such that the powder only adheres to the printed design itself (and not the unprinted film area). The powder is melted using either an oven or a heat press, and then the film is pressed face down (i.e., printed and powdered side down) onto a substrate. In some embodiments, the substrate may be a natural textile (e.g., cotton, silk, wool) or a synthetic textile (e.g., polyester, rayon, acrylic). The substrate may also include polyester coated substrates (e.g., ceramic cups, mouse pads) as well as other cellulose-based substrates. In some embodiments, the substrate may comprise one or more of one or more of cotton, cellulose, polyamide, polyvinylchloride, polyacrylate, or polyvinylacetate.

Conventional direct to film printing methods and processes use water based pigmented inks. The water based pigmented inks are inkjet printed onto a polymer coated film. These conventional processes are generally screen and/or gravure printing processes that use plastisol (polyvinylchloride/polyvinylacetate copolymer in a solvent) and an adhesive powder (i.e., copolyester) to transfer the water based pigmented inks from the polymer coated film to the substrate. Conversely, the methods and processes provided herein are specifically for direct to film printing with dye sublimation inks. To adequately transfer the dye sublimation ink from the polymer coated film to a substrate, a polyester powder is used. The polyester powder allows for adequate adhesion of dye sublimation ink printed image, which allows for adequate transfer and adhesion of the dye sublimation ink printed image to the substrate.

The improved adhesion of the dye sublimation ink to the polyester powder is due to the affinity the dye sublimation ink has to the polyester structure. Adhesion is through hydrogen bonding and van der Waals bonding which in turn is a description of the solubility with the polyester fabric. The more powder that is used, the more availability or surface the dye sublimation ink has to adhere to the polyester. This is described in further detail below.

Described below are (1) methods and processes of direct to film printing dye sublimation inks; (2) printed products prepared using a direct to film process for printing dye sublimation inks; and (3) examples.

### Methods and Processes of Direct to Film Printing Dye Sublimation Inks

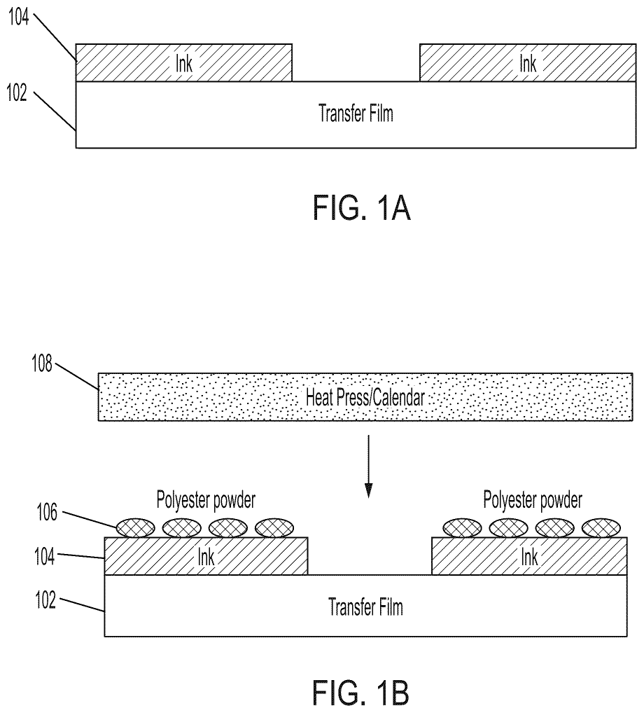

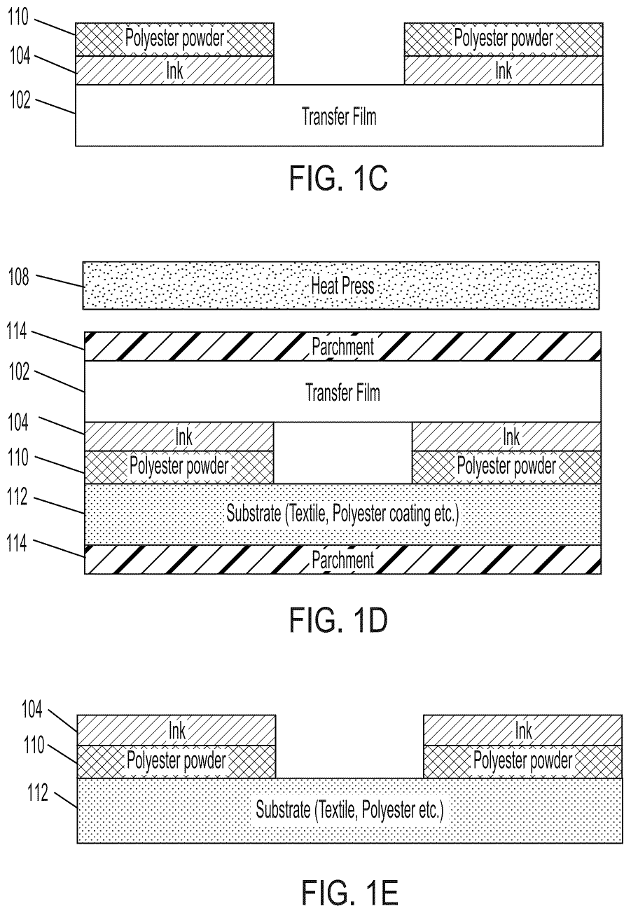

FIGS. 1A-1E show a series of figures depicting the various steps of a direct to film printing process for dye sublimation ink. Specifically, FIG. 1A shows a cross-sectional view of a printed image 104 on a polymer coated film 102. As shown, the printed image 104 (printed using dye sublimation inks) is only printed on a portion of an upper surface of the polymer coated film 102. Some portions of the polymer coated film 102 remain unprinted, or free from the printed image 104. In some embodiments, the printed image 104 may be printed using an inkjet printer. The inkjet printer may be configured to print the image using dye sublimation inks. In some embodiments, the inkjet printer used for the methods/processes described herein may also be configured to print water based pigmented inks. In this case, a single inkjet printer can be used for direct to film printing both water based pigmented inks and dye sublimation inks. This dual purpose reduces the amount of equipment and cost that would otherwise be required for two different printing processes. The inkjet printer may be equipped with either piezo or thermal printheads.

FIG. 1B shows a cross-sectional view of a dye sublimation ink printed image 104 on a polymer coated film 102 with a polyester powder 106 applied on top of the printed image 104. As shown, the polyester powder 106 is applied to the printed film (i.e., printed image 104 on the polymer coated film 102) such that the powder 106 is only applied to the printed image 104 itself (i.e., the printed dye sublimation ink) and not the exposed polymer film 102. The polyester powder 106 particulates adhere to the dye sublimation ink 104 on the polymer coated film 102. In some embodiments, to achieve this (i.e., polyester powder 106 applied only to the printed image 104 and not the exposed polymer coated film 102) may include removing excess, non-adhered polyester powder 106 from the printed film 102. Once the polyester powder 106 is applied to the printed image 104, it is heated until the polyester powder 106 melts. In some embodiments, the polyester powder 106 may comprise polyethylene terephthalate.

In some embodiments, melting the polyester powder 106 may include placing the polyester powder-coated printed film into an oven. In some embodiments, melting the polyester powder 106 may include applying a heat press 108 to the printed and powdered face of the polymer coated film 102. In some embodiments, melting the polyester powder 106 can include placing or hovering the powdered and printed polymer coated film underneath or on top of a heat source (e.g., heat press 108) until the powder 106 adequately melts. In some embodiments, the heat source (e.g., heat press 108) is applied at 392 degrees Fahrenheit for 15 seconds. In some embodiments, the heat source (e.g., heat press 108) is applied at 350-400, 375-425, or 390-395 degrees Fahrenheit. In some embodiments, the heat source is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the heat source is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the heat source is applied for 1-60, 5-30, 5-25, or 10-20 seconds. In some embodiments, the heat source is applied for less than or equal to 60, 55, 50, 45, 40, 35, 30, 25, 20, 15, 10, or 5 seconds. In some embodiments, the heat source is applied for greater than or equal to 1, 5, 10, 15, 20, 25, 30, 35, 40, 45, 50, 55, 60, 65, 70, 75, 80, 85, 90, or 95 seconds.

FIG. 1C shows a cross-sectional view of the powdered, printed image on the polymer coated film 102 once the polyester powder has melted to form a homogenous film layer 110 on top of the printed image 104. As shown, the polyester powder is no longer present on the printed image in a particle or particulate form, but instead in a thin film layer 110. The application of heat to melt the polyester powder also causes the removal of many of the volatile components of the dye sublimation ink (e.g., water, humectant).

FIG. 1D shows a cross-section view of a transferring assembly, according to some embodiments. Here, the polymer coated film 102 layered with the printed image 104 and melted polyester powder 110 is inverted and layered onto a substrate 112 (e.g., natural textile, synthetic textile). In some embodiments, this layered assembly (i.e., substrate 112—polyester thin film 110—printed image 104—polymer coated film 102) is sandwiched between two layers of parchment paper 114. With the polyester powder still melted, a heat press 108 may be applied to the transferring assembly to transfer the printed image 104 to the substrate 112. In some embodiments, the heat press 108 is applied to the assembly at 392 degrees Fahrenheit for 5 seconds. In some embodiments, the heat press 108 is applied at 350-400, 375-425, or 390-395 degrees Fahrenheit. In some embodiments, the heat press 108 is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the heat press 108 is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the heat press 108 is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the heat press 108 is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the heat press 108 is applied for 1-60, 1-30, 1-15, or 1-10 seconds. In some embodiments, the heat press 108 is applied for less than or equal to 60, 55, 50, 45, 40, 35, 30, 25, 20, 15, 10, or 5 seconds. In some embodiments, the heat press 108 is applied for greater than or equal to 1, 5, 10, 15, 20, 25, 30, 35, 40, 45, 50, 55, 60, 65, 70, 75, 80, 85, 90, or 95 seconds.

FIG. 1E shows a cross-sectional view of a printed substrate, according to some embodiments. After the heat press has been applied to the transferring assembly, as described above with respect to FIG. 1D, the polymer coated film may be removed from the assembly such that the printed image 104 and the polyester powder (in a melted thin layer 110) remain adhered to the substrate 112. As shown, this forms a layered product that includes the melted thin layer polyester powder 110 directly overlying the substrate 112 in the shape/design of the printed image, and the dye sublimation ink 104 layered on top of the polyester thin film layer 110. In some embodiments, there is no exposed polyester thin film layer 110 (i.e., the polyester powder is entirely layered with the dye sublimation ink). In some embodiments, the dye sublimation ink 104 overlies only the polyester powder thin film layer 110, and not any portion of the substrate.

As used herein, the melted polyester powder may be referred to as a thin film, thin film layer, polyester thin film layer, or the like.

As described above, the polyester powder as used herein improves the adhesion between the dye sublimation ink and the substrate. For example, with a substrate comprising cellulose fibers, the polyester powder is considered a hot melt adhesive and adheres through typical intermolecular forces as well as the melted polyester wetting out of the cellulose fibers. The polyester has similar solubility parameters to cellulose and, as such, are miscible. When cooled, the polyester becomes a solid and is “locked” into the cellulose.

In some embodiments, once the image has been transferred from the polymer coated film to the substrate 112, a post press may be applied. In some embodiments, a post press may further set the printed image into the substrate 112. In some embodiments, the post press may be applied to the printed substrate at 392 degrees Fahrenheit for 5 seconds. In some embodiments, the post press is applied at 350-400, 375-425, or 390-395 degrees Fahrenheit. In some embodiments, the post press is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the post press is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the post press is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the post press is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the post press is applied for 1-60, 1-30, 1-20, or 5-15 seconds. In some embodiments, the post press is applied for less than or equal to 60, 55, 50, 45, 40, 35, 30, 25, 20, 15, 10, or 5 seconds. In some embodiments, the post press is applied for greater than or equal to 1, 5, 10, 15, 20, 25, 30, 35, 40, 45, 50, 55, 60, 65, 70, 75, 80, 85, 90, or 95 seconds.

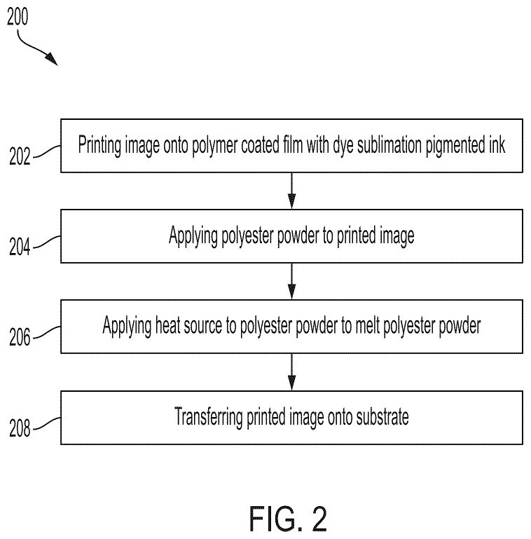

FIG. 2 shows a method 200 for direct to film printing using dye sublimation ink, according to some embodiments. At step 202, an image is printed onto a polymer coated film. The image is printed by an inject printer and dye sublimation ink. In some embodiments, the inkjet printer is equipped with piezo and/or thermal printheads. Step 202 may correspond to FIG. 1A, described above.

Any printer than can print inkjet ink can be used with the printing methods described herein. Suitable inkjet printers can include, but are not limited to, Epson SureColor F170, Epson SureColor F570, Epson SureColor F6470/H, Epson Surecolor F7200, Epson SureColor F10070/H, Epson SureColor F9470/H, Roland Texart RT-640/M, Roland Texart XT-640, Mutoh ValueJet 2638WX, Mutoh ValueJet 1948WX, Mutoh ValueJet 1938WX, Mutoh XpertJet 1682WR, Mutoh XpertJet 1642 WR Pro, Mutoh R-900x, Hewlett Packard Stitch S300, Hewlett Packard Stitch S500, Canon DGI Poseidon Dye Sublimation Printer, Canon DGI FH-3204, Canon DGI FT-3204X, Mimaki TS55-1800, Mimaki TS100-1600, Mimaki TS300P-1800, Mimaki TS330-1600, Mimaki TS500-1800, Mimaki TS500-3200, Mimaki Tiger-1800B MkIII, Mimaki CJV150, Miamki CJV300Plus, Miamki TX300P-1800B, and Mimaki TX500P-3200DS.

The polymer coated film can include a cold peel film or a hot peel film. A cold peel film uses a silicone based film on a surface of a polyethylene terephthalate (PET) plastic backing sheet, while a hot peel transfer film uses a wax based film on the surface of a PET plastic backing sheet. Cold peel films can be more uniform and provide sharper images. Once transferred, the silicone backing of a cold peel film also helps to improve the washfastness of the product, but the process is longer than that of a hot peel film. A hot peel transfer film is typically slightly less uniform and does not provide the increase in washfastness improvement as compared to a cold peel film, but it can save substantial time in the transfer process.

Suitable polymer coated films include, but are not limited to, Uninet DTF Triple Coated Sheets Film, Uninet DTF Triple Coated Film Rolls Film, Kodak FTF (Film to Fabric) Direct to Film Transfer Sheets, Kodak FTF (Film to Fabric) Direct to Film Transfer Sheets, KODACOLOR FTF (Film-to-Fabric) Cold and Hot Film, DTF Station Cut Sheet Film, DTF Station Roll Film, DTF2U 24″ Premium Single-Sided Transfer Film—Cold Peel, DTF2U ULTRA Hot Peel DTF Single-Sided Film (Hybrid/Cold Peel Too), Kingdom DTF Transfer Film Warm and Cold Pecl, Kingdom DTF Glossy Cold/Warm, Kingdom DTF Glitter Film Cold Peel, Coldesi DTF Film I Series, Coldesi DTF Film M Series, Coldesi DTF Film S Series, EcoFreen—Premium Plus, EcoFreen—Ultimate, EcoFreen—Super Quality, Forever DTF-Premium Matte, Forever DTF—Matte, Forever DTF—Glossy, Shockline—JP1MFILM75DTFTA3, Shockline—JP1MFILM75DTFCA3, or DTF Superstore—DTG Compatible Film.

Dye sublimation inks are described in more detail with respect to U.S. application Ser. No. 17/125,740, which is hereby incorporated by reference. The sublimating dye used in the present disclosure can be either a disperse/sublimating dye or a solvent dye, both of which have a sublimation property. These dyes can be used alone or as a mixture. In some embodiments, a disperse dye may provide improved dispersibility and dyeing properties. A “sublimating dye” or “sublimating pigment” as used herein is a disperse pigment that has a low enthalpy of sublimation compared to other pigments. Sublimating dyes are classified as either low energy, medium energy, or high energy and the classification is dependent on the molecular weights of the dye. A “solvent dye” as used herein is a dye that is soluble in organic solvents. Solvent dyes can also have a low enthalpy of sublimation to be used in the printing processes described herein.

Dyes that are sublimated or evaporated at 70-260° C. under atmospheric pressure are suitable for use as a sublimating dye in the methods and processes described herein. Suitable dyes include, but are not limited to, azo, anthraquinone, quinophthalone, styryl, oxazine, xanthene, methine, or azomethine. Among these dyes, examples of a yellow disperse dye include (dye name) “C. I. Disperse Yellow 51”, 54, 60, 64, 65, 71, 82, 98, 114, 119, 160, 201 and 211. Examples of an orange disperse dye include “C. I. Disperse Orange 25”, 33, 44, and 288. Examples of a red disperse dye include “C. I. Disperse Red 4”, 22, 55, 59, 60, 73, 86, 91, 146, 152, 191, 302, and 364. Examples of a blue disperse dye include “C. I. Disperse Blue 14”, 28, 56, 60, 72, 73, 77, 334, 359, 360 and 366. Other color components can include “C. I. Disperse Brown 27”; “C.I. Disperse Violet 26”, 27, 28 and the like. Examples of the other solvent dye include “C. I. Solvent Yellow 16”, 33, 93, and 160; “C. I. Solvent Orange 60”; “C. I. Solvent Red 111”, 155; “C. I. Solvent Violet 31”; “C. I. Solvent Blue 35”, 36, 59, 63, 97, and 104.

The dye sublimation inks used with the methods and processes described herein may include any of the dye sublimation inks described in U.S. application Ser. No. 17/125,740. The dye sublimation inks described in the above-mentioned U.S. application Ser. No. 17/125,740 may be configured such that they do not dry as quickly on the polymer coated film as compared to other dye sublimation inks. This can maximize the amount of polymer powder that adheres to the printed areas through capillary forces. This can also encourage a more complete transfer of the ink from the polymer coated film to the substrate. However, other dye sublimation inks may also be used with the printed methods and processes described herein. In some embodiments, the dye sublimation ink used with the processes and methods described herein can include humectants, surfactants, additives (e.g., biocides/antioxidants/UV absorbers/chelating agents) and a dye/pigment. Other suitable dye sublimation inks include, but are not limited to, Mimaki SB53, Mimaki SB54, Mimaki SB210, Mimaki SB300, Mimaki SB310, Mimaki SB320, Mimaki SB410, Mimaki SB411, Mimaki SB420, Mimaki SB610, Mimaki MLSb510, Mimaki MLSb520, Epson T49M for F170 Printers, Epson T53K for F6470 Printers, Epson T46C for F9470/H Printers, Epson T43F for F10070/H Printers, Mutoh DH21 Dye Sublimation Ink, Roland DG Texart SBL3 Dye Sublimation Inks, Hewlett Packard 624 Dye Sublimation Inks, Hewlett Packard 614 Dye Sublimation Inks, Hewlett Packard 636 Dye Sublimation Inks, or Hewlett Packard 638 Dye Sublimation Inks.

At step 204, a polyester powder is applied to the printed image on the polymer coated film. The polyester powder may be applied using either manual or mechanical application methods. The polyester powder is used because it is uniquely equipped to adhere to dye sublimation inks. Specifically, the polyester powder adheres to the dye sublimation ink using capillary action. The adequacy of the adhesion of the powder to the printed image directly correlates to the adequacy of the image being transferred to the substrate. Unlike other powders commonly used in direct to film printing processes, polyester powder has a relatively higher surface area to volume ratio, which provides more adhesion sites for the dye sublimation inks. More adhesion sites can increase wash fastness and color density. The increased amount of polyester powder that can adhere to the dye sublimation ink (e.g., increased weight percent) can also increase the amount of dye sublimation ink that is effectively transferred from the polymer coated film to the substrate as compared to other printing methods. Further, applying the polyester as a powder to the dye sublimation ink printed image as opposed to a polymer dispersion (which can be done in other direct to film printing methods) minimizes the possibility of any instabilities that may occur due to large temperature extremes found during transportation or pH changes in the solution overtime. The addition of the polymer after printing also acts as a weedless process as no polymer adheres to the film which does not contain ink.

In some embodiments, the amount of polyester powder that is applied to and adheres to the printed dye sublimation ink image is 0.01-1, 0.01-1, or 0.03-0.05 g powder/in² ink. In some embodiments, the amount of powder applied is less than or equal to 1, 0.9, 0.8, 0.7, 0.6, 0.5, 0.4, 0.3, 0.2, 0.1, 0.09, 0.08, 0.07, 0.06, 0.05, 0.04, 0.03, or 0.02 g powder/in² ink. In some embodiments, the amount of powder applied is 0.01, 0.02, 0.03, 0.04, 0.05, 0.06, 0.07, 0.08, 0.09. 0.1, 0.2, 0.3, 0.4, 0.5, 0.6, 0.7, 0.8, or 0.9 g powder/in² ink.

Any polyester powder can be used with the printing processes and methods described herein, but many properties of the printed product (e.g., how soft the transfer is as well as how much elongation) may depend on the physical properties of the polyester polymer. Softer image transfers will be dependent on the molecular weight of the powder, differences in the moieties of the main chain, types of primary and secondary bonding and the level of crystallinity. The melting point range of polyester polymers can be as low as 58-330° C. In some embodiments, polyester polymers have a melting point of 58-110° C. are preferred.

In some embodiments, the polyester powder may include one or more of one or more of polyethylene terephthalate, polybutylene terephthalate, polyethylene naphthalate, polytrimethylene terephthalate, polycaprolactone, polylactic acid, polyhydroxybutyrate, polyglycolide, or poly(ethylene adipate). Suitable commercially available polyester powders can include, but are not limited to, those manufactured by Fixatti (e.g., PES T3, PES T4/374, PES T5, PES T6/376, PES T7/386, PES 386 F, PES T14, PES E20, PES 3320, PES 3230, PES 3730, PES 3820 MC, PES 3825 DC, PES 3820 MC, PES 3825 DC), Stepan (e.g., Rucote 5001, Rucote 5006, Rucote 109, Rucote 9900, Rucote 117, Rucote 5500, Rucote XP 5500, Rucote 9008, Rucote 561, Rucote 106, Rucote 121, Rucote 118, Rucote 921, Rucote 108, Rucote 104, Rucote 102, Rucote 921, Rucote 123, Rucote 561, Rucote 560, Rucote 562, Rucote 570, Rucote 107, Rucote 9011, Rucote 9010, Rucote 5016, Rucote XP 9014, Rucote 9400, Rucote 9006, Rucote 9110), Lyondellbasell (e.g., Accucomp PET 008L, Icorene N9201, Icorene N9204, Icorene N9206, Icorene N9207, Matrixx 80M7451, Matrixx 80S7150, Matrixx 80S7351, Matrixx 80S7451, Matrixx 81N7004, MatrixX 85S7451, QR Resin QR 3000, QR Resin QR 3000 GF30, Schuladur E GF 30 FR5, Schuladur E GF 35 Schawrz, Chuladur E GF 50), Amco Polymers (e.g., Primatop PET GP68-HP, Primatop PET GP80), Americhem (e.g., InElec PCT7011AS, InElec PCT7011AS10, InElec PCT7031AS), BASF (e.g., Petra 130, Petra 130 BK112, Petra 130FR, Petra 130 FR BK 112, Petra 140, Petra 230 BK112, Petra 330 FR, Petra 330 FR BK112, Petra 7010 BK5830), Celanese (e.g., Impet 2700 GV1/30, Impet 2700 GV1/30, Impet 2700 GV1/45, Impet 2700A GV1/30FC, Impet 330R, Impet 340R, Impet 5206HG, Impet 830R, Impet HD250), Eastman Chemical Company (e.g., Eastar EN058 Natural), Sabic (e.g., LNP Colorcomp WQ117945), DAK Americas (e.g., DAK Americas Laser+® C91A PET, DAK Americas Laser+® MB912 PET, DAK Americas Laser+® 7000 (C91A) PET, DAK Americas Laser+® HP806 (B93A) PET, DAK Americas Laser+® B90A PET, DAK Americas Laser+® B90B PET, DAK Americas Laser+® C C61A PET, DAK Americas Laser+® C E61A PET, DAK Americas Laser+® C K62A PET, DAK Americas Laser+® C 4800 B66A PET, DAK Americas Laser+® C 9000 (B64A) PET, DAK Americas Laser+® C 9921 (F65A) PET, DAK Americas Laser+® C 61803 (E67A) PET, DAK Americas Laser+® C (C60A) PET, DAK Americas Laser+® C (E60A) PET, DAK Americas Laser+® HS D59A PET, DAK Americas Laser+® HS CF746A (D53A) PET, DAK Americas Laser+® HS AD600A PET, DAK Americas Laser+® HS Ti818 (G51A) PET, DAK Americas Laser+® W L44A PET, DAK Americas Laser+® W L44B PET, DAK Americas Laser+® W P45A PET, DAK Americas Laser+® W 4000 K42A PET, DAK Americas Laser+® W PJ002 F43A PET, DAK Americas Laser+® W Ti844 P46A PET, DAK Americas Laser+® W L40A PET, DAK Americas Laser+® W L40B PET, DAK Americas Laser+® W P41A PET), or DSM (e.g., DSM Arnite® AM8527 (G) PET-GF, 3D Printing Grade, DSM Arnite® ID 3040 PET, 3D Printing Grade, DSM Arnite® AV2 390 XT PET GF50, DSM Arnite® AV2 390 XL PET GF50, DSM Arnite® AV2 370 XT PET-GF35, DSM Arnite® AV2 370 XL-T PET-GF35, DSM Arnite® AV2 370 XL PET-GF35, DSM Arnite® AV2 370 HF PET-GF35, DSM Arnite® A02 307 PET).

Step 204 may correspond to FIG. 1B as described above.

At step 206, a heat source may be applied to the polyester powder applied to the dye sublimation ink printed image on the polymer coated film to melt the polyester powder. For example, melting the polyester powder may include placing the polyester powder-coated printed film into an oven. In some embodiments, melting the polyester powder may include applying a heat press to the printed and powdered face of the polymer coated film. In some embodiments, melting the polyester powder can include placing or hovering the powdered and printed polymer coated film underneath or on top of a heat source until the powder adequately melts. The heat source/method can include conductive heating or an infrared radiative heater. Any heating process can be used, so long as the heat does not degrade the polymer backing of the film. This application of heat can also remove some of the volatile components of the dye sublimation ink. In some embodiments, the heat source is applied at 392 degrees Fahrenheit for 15 seconds. In some embodiments, the heat sources is applied at 350-400, 375-425, or 390-395 degrees Fahrenheit. In some embodiments, the heat source is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the heat source is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the heat source is applied for 1-60, 5-30, 5-25, or 10-20 seconds. In some embodiments, the heat source is applied for less than or equal to 60, 55, 50, 45, 40, 35, 30, 25, 20, 15, 10, or 5 seconds. In some embodiments, the heat source is applied for greater than or equal to 1, 5, 10, 15, 20, 25, 30, 35, 40, 45, 50, 55, 60, 65, 70, 75, 80, 85, 90, or 95 seconds.

In some embodiments, step 206 may correspond to FIG. 1B, described in detail above.

At step 208, the dye sublimation ink printed image is transferred from the polymer coated film to the substrate. This can occur by inverting the powder-coated printed polymer film such that the printed side or face of the polymer coated film is applied face-down on the substrate to form a transferring assembly. The transferring assembly includes a polyester powder layer overlying a substrate layer, a dye sublimation ink layer overlying the polyester powder layer, and a polymer coated film layer overlying the dye sublimation ink layer. In some embodiments, the polyester powder layer does not cover the entire surface of the substrate. Instead, the polyester powder layer corresponds to the printed image design of the dye sublimation ink layer. In some embodiments, the dye sublimation ink layer does cover the entire polyester powder layer. However, in most cases, there will be void space formed by the polyester powder and dye sublimation ink pigmented ink layers such that there are areas in the transferring assembly that do not include any polyester powder nor any dye sublimation ink between the substrate and the polymer coated film.

Once the transferring assembly is formed, it may be treated with a heat press to cause the transfer of adhesion of the polymer powder layer and the dye sublimation ink layer from the polymer coated film to the substrate. In some embodiments, the heat press is applied to the assembly at 392 degrees Fahrenheit for 5 seconds. In some embodiments, the heat press is applied at 350-400, 375-425, or 390-395 degrees Fahrenheit. In some embodiments, the heat press is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the heat press is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the heat press is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the heat press is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the heat press is applied for 1-60, 1-30, 1-15, or 1-10 seconds. In some embodiments, the heat press is applied for less than or equal to 60, 55, 50, 45, 40, 35, 30, 25, 20, 15, 10, or 5 seconds. In some embodiments, the heat press is applied for greater than or equal to 1, 5, 10, 15, 20, 25, 30, 35, 40, 45, 50, 55, 60, 65, 70, 75, 80, 85, 90, or 95 seconds. In some embodiments, the heat press is applied to the transferring assembly sandwiched between to sheets of parchment paper. The parchment paper can help retain moisture within the transferring assembly. The parchment paper helps to retain some of the moisture that was used to transfer the lower printed ink areas. Specifically, the parchment paper may act by holding the humectant and water of the dye sublimation ink within the substrate longer, allowing for more adequate transfer of the image. After the heat press has been applied to the transferring assembly and the printed image (i.e., dye sublimation ink and polyester powder) have adequate adhesion to the substrate (and no longer to the polymer coated film), the polymer coated film can be removed from the assembly to produce the printed product (i.e., polyester powder and dye sublimation ink printed image onto the substrate).

In some embodiments, step 208 may correspond to FIG. 1D, described in detail above.

In some embodiments, an option post press may be applied to the printed product to further set the printed/transferred image. In some embodiments, the post press may be applied to the printed substrate at 392 degrees Fahrenheit for 5 seconds. In some embodiments, the post press is applied at 350-400, 375-425, or 390-395 degrees Fahrenheit. In some embodiments, the post press is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the post press is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the post press is applied at less than or equal to 450, 445, 440, 435, 430, 425, 420, 415, 410, 405, 400, 395, 390, 385, 380, 375, 370, 365, 360, or 355 degrees Fahrenheit. In some embodiments, the post press is applied at greater than or equal to 350, 355, 360, 365, 370, 375, 380, 385, 390, 395, 400, 405, 410, 415, 420, 425, 430, 435, 440, or 445 degrees Fahrenheit. In some embodiments, the post press is applied for 1-60, 1-30, 1-20, or 5-15 seconds. In some embodiments, the post press is applied for less than or equal to 60, 55, 50, 45, 40, 35, 30, 25, 20, 15, 10, or 5 seconds. In some embodiments, the post press is applied for greater than or equal to 1, 5, 10, 15, 20, 25, 30, 35, 40, 45, 50, 55, 60, 65, 70, 75, 80, 85, 90, or 95 seconds.

### Printed Products Prepared Using the Direct to Film Methods and Processes Described

Also provided herein are printed products prepared using the printing methods and processes described herein.

The printed products provided include a dye sublimation ink-printed image or design transferred onto a substrate. In some embodiments, the substrate may comprise a textile. For example, the substrate may comprise a natural textile (e.g., cotton, wool, silk). In some embodiments, the substrate may comprise a synthetic textile (e.g., rayon, polyester, acrylic).

The image or design that has been transferred onto the substrate was achieved using the methods and processes described herein. Specifically, the image is printed onto a polymer coated film using dye sublimation ink and an inkjet printer. A polyester powder is applied to the printed image on the polymer coated film and melted. The powdered-printed film is then applied to the substrate such that the dye sublimation ink printed image and polyester powder coating on the printed image is between the polymer coated film and the substrate. With the application of heat, the dye sublimation ink image and polyester powder are transferred from the polymer coated film to the substrate. In some embodiments, the substrate does not need to be pretreated prior to the direct to film printing process/method.

### Testing Methods

Various chemical and physical properties may be used to characterize the sufficiency of direct to film printed product. Discussed below are properties used for characterizing printed substrates and the testing methods used for each.

Colorfastness to Laundering: A printed fabric's colorfastness determines its ability to retain its depth and shade throughout the life of the product, and in particular, throughout laundering of the product. Ideally, a printed image on a fabric can withstand the lifetime of the product without significantly compromising the quality (e.g., depth, shade) of the printed image. The colorfastness of a printed natural fiber fabric may be tested using Method 1 and/or Method 2, the method described below.

Colorfastness to laundering may be tested by placing a printed fabric sample measuring 8.5 inches by 5.5 inches in a consumer washing machine and washed for 15 minutes with room temperature water and 0.5 g of detergent (such as Tide® detergent or Woolite® Delicate detergent) per 0.5 L of water. A standard wash cycle was used (cotton/medium) with a standard spin cycle. (The sample was washed with 9-14 other printed fabric samples). The printed fabric sample was rinsed with 0.5 L water per sample for six minutes. The sample(s) was then spin-dried for five minutes and then further dried until dry (for example, by placing in an oven at 60° C. until dry or hang drying at room temperature until dry).

The washed and dried samples were analyzed using a Gretag spectrophotometer for optical density, L, a*, and b* values. The inks were printed onto Wing Wing Hybrid transfer paper using, for example, a 2 Krod at speed 10 on a K Control Coater (RKPrint) or a Mutoh 901X printer. The image was transferred, for example, at 392° F. for 40 seconds or 385° F. for 35 seconds.

Fabric Hand: The hand of a fabric measures the “feel” of the fabric against skin. The hand of a fabric can change with the printing of an image on the fabric. However, it is generally not desirable for the printed image to significantly impact the hand of the fabric, particularly for wearable products. The hand of a fabric was measured using standard AATCC EP 5 (referring to the American Association of Fabric Chemists and Colorists standards) Guidelines to the Subjective Evaluation of Fabric Hand. This standard uses a scale of 1-5 to characterize the hand of the fabric, where 1 is worst and 5 is best.

Crock Testing: Crock refers to the transfer of ink/dye from the fabric to another. For example, if the ink/dye of a printed image does not sufficiently adhere to the fabric, it may transfer to another substrate that it contacts. Ideally, the ink/dye of a printed image sufficiently adheres to the fabric to minimize any tendency for the ink/dye to crock. Crock may be tested using standard AATCC 8 Colorfastness to Crock: Crockmeter Method and a scale of 1 to 5, 5 being the best, and 1 being the worst. AATCC 8 includes testing methods for wet crock and dry crock as well.

### EXAMPLES

### Example 1: Washability and Crock

Below, Table 1 shows washability and crock test results for three different dye sublimation ink printing processes. As shown, the three different printing processes include dye sublimation standard, dye sublimation fuze, and dye sublimation direct to printing with polyester (polyethylene terephthalate, PET) powder. The dye sublimation standard process includes using just a standard dye sublimation paper and transferring to cotton as opposed to polyester. The dye sublimation fuze process is the application of the pretreatment on a cotton substrate before the transfer of the dye sublimation ink on standard transfer paper.

As shown, the washability test results show the initial optical density, as well as the optical density after one, three, and five washes. The third printing process (“dye sub PET powder”), and that which is described herein, includes a noticeably higher optical density than that of the other two processes tested for each of the initial, first, third, and fifth washing values. Additionally, the ΔE for the third printing process and that which is described herein for the initial, first, third, and fifth washes are also considerably less than those of the other printing processes. These results are all consistent for each of the ink colors (i.e., cyan, magenta, yellow, and black). This demonstrates that the printing methods and processes described herein have between washability than dye sublimation standard and dye sublimation fuze printing processes.

Also shown in Table 1 are wet and dry crock. The third printing process and that which is described herein shows better results for both wet and dry crock as compared to both the dye sublimation standard and dye sublimation fuze printing processes. These results are all consistent for each of the ink colors (i.e., cyan, magenta, yellow, and black).

Finally, the fabric hand is also improved with the third printing process and that which is described herein as compared to that which is demonstrated by both the dye sublimation standard and dye sublimation fuze printing processes. These results are all consistent for each of the ink colors (i.e., cyan, magenta, yellow, and black).

TABLE 1

| | Transfer | Transfer | Transfer | |
|---|---|---|---|---|
| | Dye Sub | Dye Sub | Dye Sub | |
| | Standard | Fuze | PET Powder | |
| | Cyan | Cyan | Cyan | |
| | Optical Density | | | Method |
| Initial | 0.53 | 1.18 | 1.314 | Wash |
| Wash 1 | 0.25 | 1.03 | 1.238 | Method 1 |
| Wash 3 | 0.17 | 0.94 | 1.1 | |
| Wash 5 | 0.14 | 0.89 | 1.164 | |
| | DE_{ab(1976)} | | | Method |
| DE Wash 1 | 24.5 | 9.0 | 2.9 | ASTM |
| DE Wash 3 | 28.8 | 13.8 | 5.2 | D2244-16 |
| DE Wash 5 | 30.1 | 17.0 | 5.5 | |
| | | | | Method |
| Crock Wet | 3-4 | 2-3 | 5 | AATC 8 |
| Crock Dry | 4 | 4-5 | 5 | |
| Fabric Hand | 5 | 3 | 2.5 | AATCC 5 |
| | Transfer | Transfer | Transfer | |
| | Dye Sub | Dye Sub | Dye Sub | |
| | Standard | Fuze | PET Powder | |
| | Magenta | Magenta | Magenta | |
| | Optical Density | | | Method |
| Initial | 0.74 | 1.24 | 1.33 | Wash |
| Wash 1 | 0.27 | 1.12 | 1.216 | Method 1 |
| Wash 3 | 0.18 | 1.02 | 1.194 | |
| Wash 5 | 0.17 | 0.99 | 1.172 | |
| | DE_{ab(1976)} | | | Method |
| DE Wash 1 | 38.7 | 9.2 | 4.5 | ASTM |
| DE Wash 3 | 46.5 | 12.8 | 6.1 | D2244-16 |
| DE Wash 5 | 48.1 | 16.8 | 7.2 | |
| | | | | Method |
| Crock Wet | 1-2 | 3 | 5 | AATC 8 |
| Crock Dry | 2-3 | 4-5 | 5 | |
| Fabric Hand | 5 | 3 | 2.5 | AATCC 5 |
| | Transfer | Transfer | Transfer | |
| | Dye Sub | Dye Sub | Dye Sub | |
| | Standard | Fuze | PET Powder | |
| | Yellow | Yellow | Yellow | |
| | Optical Density | | | Method |
| Initial | 0.63 | 1.3 | 1.378 | Wash |
| Wash 1 | 0.38 | 1.15 | 1.28 | Method 1 |
| Wash 3 | 0.258 | 1.05 | 1.22 | |
| Wash 5 | 0.25 | 0.9 | 1.21 | |
| | DE_{ab(1976)} | | | Method |
| DE Wash 1 | 23.6 | 14 | 4.5 | ASTM |
| DE Wash 3 | 33.1 | 19.9 | 7.4 | D2244-16 |
| DE Wash 5 | 34.2 | 33.1 | 8 | |
| | | | | Method |
| Crock Wet | 3-4 | 3 | 5 | AATC 8 |
| Crock Dry | 4 | 4-5 | 5 | |
| | | | | Method |
| Fabric Hand | 5 | 3 | 2.5 | AATCC 5 |
| | Transfer | Transfer | Transfer | |
| | Dye Sub | Dye Sub | Dye Sub | |
| | Standard | Fuze | PET Powder | |
| | Black | Black | Black | |
| | Optical Density | | | Method |
| Initial | 0.71 | 1.13 | 1.34 | Wash Method 1 |
| Wash 1 | 0.38 | 0.98 | 1.186 | |
| Wash 3 | 0.25 | 0.91 | 1.164 | |
| Wash 5 | 0.26 | 0.81 | 1.154 | |
| | DE_{ab(1976)} | | | Method |
| DE Wash 1 | 19.2 | 5.8 | 5.4 | ASTM |
| DE Wash 3 | 28.6 | 9.1 | 6.1 | D2244-16 |
| DE Wash 5 | 30.5 | 14 | 6.5 | |
| | | | | Method |
| Crock Wet | 2-3 | 3 | 5 | AATC 8 |
| Crock Dry | 2-3 | 4-5 | 5 | |
| | | | | Method |
| Fabric Hand | 5 | 3 | 2.5 | AATCC 5 |

The preceding description sets forth exemplary methods, parameters and the like. It should be recognized, however, that such description is not intended as a limitation on the scope of the present disclosure but is instead provided as a description of exemplary embodiments. The illustrative embodiments described above are not meant to be exhaustive or to limit the disclosure to the precise forms disclosed. Many modifications and variations are possible in view of the above teachings. The embodiments were chosen and described to best explain the principles of the disclosed techniques and their practical applications. Others skilled in the art are thereby enabled to best utilize the techniques, and various embodiments with various modifications as are suited to the particular use contemplated.

Although the disclosure and examples have been thoroughly described with reference to the accompanying figures, it is to be noted that various changes and modifications will become apparent to those skilled in the art. Such changes and modifications are to be understood as being included within the scope of the disclosure and examples as defined by the claims. In the preceding description of the disclosure and embodiments, reference is made to the accompanying drawings, in which are shown, by way of illustration, specific embodiments that can be practiced. It is to be understood that other embodiments and examples can be practiced, and changes can be made without departing from the scope of the present disclosure.

Although the preceding description uses terms first, second, etc. to describe various elements, these elements should not be limited by the terms. These terms are only used to distinguish one element from another.

Also, it is also to be understood that the singular forms “a,” “an,” and “the” used in the preceding description are intended to include the plural forms as well unless the context indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” may be construed to mean “when” or “upon” or “in response to determining” or “in response to detecting,” depending on the context.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

1. A method for direct to film printing dye sublimation ink comprising:
inkjet printing a design on a polymer coated film using dye sublimation ink;
applying a polyester powder to the printed design on the polymer coated film to form a powdered printed design;
melting the polyester powder; and
transferring the powdered printed design from the polymer coated film to a substrate.

2. The method of claim 1, wherein inkjet printing a design on a polymer coated film using dye sublimation ink comprises inkjet printing using an inkjet printer comprising piezo or thermal printheads.

3. The method of claim 1, wherein melting the polyester powder comprises applying a heat source to the powdered printed design for 390-395° C. for 10-20 seconds.

4. The method of claim 1, wherein the heat source comprises conductive heating or an infrared radiative heater.

5. The method of claim 1, wherein transferring the powdered printed design from the polymer coated film to a substrate comprises applying a heat press to the polymer coated film comprising the powdered printed design pressed face down on the substrate.

6. The method of claim 1, wherein the heat press is applied at 390-395° C. for 1-10 seconds.

7. The method of claim 1, wherein after the printed design is transferred to the substrate, the polymer coated film is removed from the printed design, forming a printed substrate.

8. The method of claim 1, comprising post pressing the printed substrate at 390-395° C. for 10-20 seconds.

9. The method of claim 1, wherein applying a polyester powder to the printed design on the polymer coated film to form a powdered printed design comprises applying 0.03-0.05 g powder/in² ink to the printed design.

10. The method of claim 1, wherein the substrate comprises one or more of cotton, cellulose, polyamide, polyvinylchloride, polyacrylate, or polyvinylacetate.

11. The method of claim 1, wherein the polyester powder comprises one or more of polyethylene terephthalate, polybutylene terephthalate, polyethylene naphthalate, polytrimethylene terephthalate, polycaprolactone, polylactic acid, polyhydroxybutyrate, polyglycolide, or poly(ethylene adipate).

12. The method of claim 1, wherein the polymer coated film is a cold peel film.

13. The method of claim 1, wherein the polymer coated film is a hot peel film.

14. A printed product prepared from a method for direct to film printing dye sublimation ink comprising the steps of:
inkjet printing a design on a polymer coated film using dye sublimation ink;
applying a polyester powder to the printed design on the polymer coated film to form a powdered printed design;
melting the polyester powder; and
transferring the powdered printed design from the polymer coated film to a substrate to form a printed product.

15. The printed product of claim 14, wherein inkjet printing a design on a polymer coated film using dye sublimation ink comprises inkjet printing using an inkjet printer comprising piezo or thermal printheads.

16. The printed product of claim 14, wherein melting the polyester powder comprises applying a heat source to the powdered printed design for 390-395° C. for 10-20 seconds.

17. The printed product of claim 14, wherein the heat source comprises conductive heating or an infrared radiative heater.

18. The printed product of claim 14, wherein transferring the powdered printed design from the polymer coated film to a substrate comprises applying a heat press to the polymer coated film comprising the powdered printed design pressed face down on the substrate.

19. The printed product of claim 14, wherein the heat press is applied at 390-395° C. for 1-10 seconds.

20. The printed product of claim 14, wherein after the printed design is transferred to the substrate, the polymer coated film is removed from the printed design, forming a printed substrate.

21. The printed product of claim 14, comprising post pressing the printed substrate at 390-395° C. for 10-20 seconds.

22. The printed product of claim 14, wherein applying a polyester powder to the printed design on the polymer coated film to form a powdered printed design comprises applying 0.03-0.05 g powder/in² ink to the printed design.

23. The printed product of claim 14, wherein the substrate comprises one or more of cotton, cellulose, polyamide, polyvinylchloride, polyacrylate, or polyvinylacetate.

24. The printed product of claim 14, wherein the polyester powder comprises one or more of polyethylene terephthalate, polybutylene terephthalate, polyethylene naphthalate, polytrimethylene terephthalate, polycaprolactone, polylactic acid, polyhydroxybutyrate, polyglycolide, or poly(ethylene adipate).

25. The printed product of claim 14, wherein the polymer coated film is a cold peel film.

26. The printed product of claim 14, wherein the polymer coated film is a hot peel film.
